(19) United States
(12) Patent Application Publication
(10) Pub. No.: US 2026/0049708 A1
(43) Pub. Date: Feb. 19, 2026

(54) PLANAR ILLUMINATION DEVICE

(71) Applicant: MINEBEA MITSUMI Inc., Nagano (JP)

(72) Inventors: Ginga ITO, Kitasaku-gun (JP); Masaya FUJIWARA, Kitasaku-gun (JP)

(21) Appl. No.: 19/101,954

(22) PCT Filed: Jul. 6, 2023
(86) PCT No.: PCT/JP2023/025062

§ 371 Date: Feb. 7, 2025

(30) Foreign Application Priority Data
Aug. 9, 2022 (JP) 2022-127388

(51) Int. Cl. F21V 13/04; F21V 5/04; F21V 7/00; F21Y 105/10

(52) U.S. Cl. CPC F21V 13/04; F21V 5/045; F21V 7/0083; F21Y 2105/10

(57) ABSTRACT

A planar illuminating device of an embodiment is a directly-under type planar illuminating device provided with a linear Fresnel lens, and comprises a plurality of light sources, and a reflector. The plurality of light sources are disposed in a linear fashion on a board, along condensing positions of the Fresnel lens. The reflector includes reflecting surfaces constituting segments surrounding each of the light sources. In a part in which the light sources cannot be disposed along the condensing position because a planar shape of a light emitting area of the planar illuminating device is an irregular shape that is not rectangular, the segment of the reflector adjacent to said part is expanded to an outer edge side of the planar illuminating device.

### CROSS REFERENCE TO RELATED APPLICATIONS

This application is a national stage entry of International Application No. PCT/JP2023/025062, filed on Jul. 6, 2023, which claims priority to Japanese Patent Application 2022-127388, filed on Aug. 9, 2022, which is incorporated herein by reference.

### TECHNICAL FIELD

The disclosure relates to a planar illumination device.

### BACKGROUND

A direct-type planar illumination device having a linear Fresnel lens has been proposed (see WO 2022/004036, or the like). By using the linear Fresnel lens, light distribution is efficiently performed, and high luminance, high luminance uniformity, low power consumption, and thinning, or the like are achieved.

In addition, when the planar shape (light-emitting surface shape) of a light source is irregular, a planar light source has been proposed with luminance unevenness occurring around the planar shape reduced (e.g., see JP 2021-190417 A, or the like).

### SUMMARY

However, in the case where the planar shape of a direct-type planar illumination device having a linear Fresnel lens is irregular, the elimination of luminance unevenness in the irregular shape area has not been studied, and a solution to this problem has been requested.

In the direct-type planar illumination device having a linear Fresnel lens, light sources such as Light Emitting Diodes (LEDs) need to be linearly arranged along the light condensing position (focal point) of the linear Fresnel lens. However, when the planar shape of the light emitting area is irregular and not rectangular, linearly arranging the light sources becomes difficult along the light condensing position of the linear Fresnel lens up to the end part of the light emitting area due to the structural restriction of the frame edge part, degrading luminance uniformity due to the occurrence of dark area.

The disclosure has been made in view of the above, and an object of the disclosure is to provide a planar illumination device capable of preventing the occurrence of a dark area in the irregular shape area and improving luminance uniformity.

In order to solve the above problems and achieve the object, a planar illumination device according to one aspect of the disclosure is a direct-type planar illumination device, and includes a plurality of light sources and a reflector. The reflector having a plurality of reflective surfaces forming respective segments, each segment surrounding a corresponding one of the plurality of light sources. At an area not enabling arrangement of the light sources because a planar shape of a light emitting area of the planar illumination device is irregular and non-rectangular, a segment of the reflector adjacent to the area is extended toward an outer edge side of the planar illumination device.

The planar illumination device according to an aspect of the disclosure can prevent a dark area from occurring at the irregular shape area and can improve the luminance uniformity.

### BRIEF DESCRIPTION OF DRAWINGS

FIG. 1 is an external perspective view of a planar illumination device according to an embodiment.

FIG. 2 is an exploded perspective view of a main part of a planar illumination device.

FIG. 3 is a plan view of a reflector.

FIG. 4 is a simplified view illustrating a light emitting area of the planar illumination device and a light condensing position locating the light sources.

FIG. 5 is a cross-sectional view of a planar illumination device corresponding to the X-X section of FIG. 4.

FIG. 6 is an enlarged view of an extension section of a condenser lens.

FIG. 7 is a view (1) illustrating an example with a dark area occurring in a planar illumination device of a comparative example due to a planar shape of the light emitting area being irregular and non-rectangular.

FIG. 8 is a view (2) illustrating an example with a dark area occurring in a planar illumination device of a comparative example due to a planar shape of the light emitting area being irregular and non-rectangular.

FIG. 9 is a view of an example of a light emitting area, and a light condensing position arranging light sources, in a planar illumination device of a comparative example.

FIG. 10 is a cross-sectional view of a planar illumination device corresponding to the X-X section of FIG. 9.

### DESCRIPTION OF EMBODIMENTS

A planar illumination device according to an embodiment will be described below with reference to the drawings. The disclosure is not limited by this embodiment. In addition, in the drawings, the relationship between the dimensions of each element and the ratio of each element may differ from reality. Even between the drawings, there may be portions having the relationships and ratios of the dimensions different from each other. In principle, the contents described in one embodiment or modification are similarly applied to other embodiments or modifications.

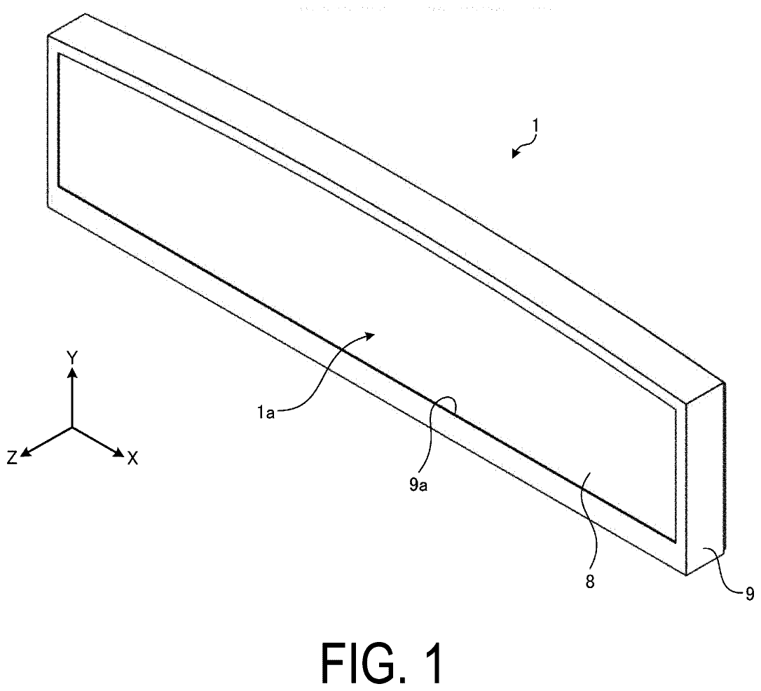

FIG. 1 is an external perspective view of a planar illumination device 1 according to an embodiment. In the drawing, for convenience, the longitudinal direction of the planar illumination device 1 is an X-axis direction, the lateral direction is a Y-axis direction, and the thickness direction is a Z-axis direction. However, the orientation during use is random.

In FIG. 1, the planar illumination device 1 has a substantially rectangular (or substantially square) and plate-like outer shape. A housing is composed of a bottom frame (hidden behind the drawing) in the shape of a box with a floor for accommodating substrates or the like described later, and a top frame 9 covering the opening side of the bottom frame. An exit surface la (light emitting area) is formed at the top frame 9 by a substantially rectangular opening 9a, and light is emitted from the inside of the planar illumination device 1 toward the outside. In the drawing, an optical sheet 8 inside is exposed to the exit surface la. Details of the shape (irregular shape) of the opening 9a (exit surface la) will be described below. When the planar illumination device 1 is used as a backlight for a vehicle-mounted display such as a cluster meter, a Center Information Display (CID), a head-up display and an indicator, a liquid crystal display device or the like is mounted at the exit surface la side.

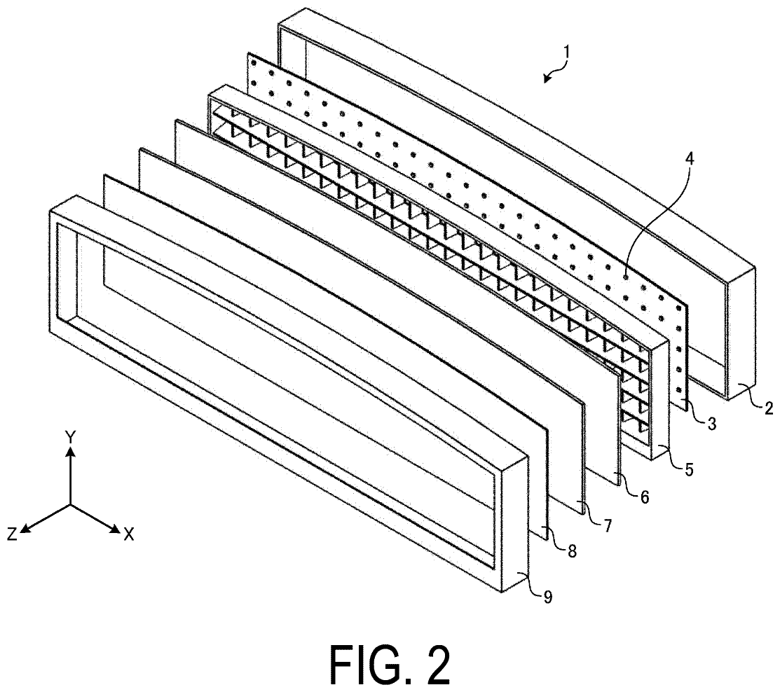

FIG. 2 is an exploded perspective view of the main part of the planar illumination device 1, and is viewed from the exit surface side as in FIG. 1. In FIG. 2, the planar illumination device 1 consists of a substrate 3, a plurality of (many) light sources 4 being arranged at the substrate 3; a reflector 5; a condenser lens 6; a light distribution and field-of-view adjustment lens 7; and the optical sheet 8 attached to a bottom frame 2, and the top frame 9 fitting outside the bottom frame 2 to cover the bottom frame 2.

The bottom frame 2 has a bottom part and four-sided sidewalls provided at the outer periphery of the bottom part. The bottom frame 2 is formed by die casting, sheet metal, or the like. The substrate 3 is fixed inside the bottom part of the bottom frame 2 through a fixing member (not illustrated) such as a double-sided tape. On the substrate 3, for example, light sources 4 composed of a plurality of (many) Light Emitting Diodes (LEDs) or the like, are arranged in a grid pattern. The plurality of light sources 4 can be driven by local dimming and are electrically connected so as to be individually lit. The luminance uniformity is further improved by adjusting the emission intensity of each light source 4.

The back surface of the reflector 5 is fixed between the light sources 4 on the substrate 3 via a fixing member (not illustrated) composed of a plurality of double-sided strips or the like extending in the left-right direction (or the vertical direction) of the drawing. The reflector 5 has reflective surfaces surrounding each light source 4, and reflects light emitted at a wide angle from the light source 4 to the exit surface side to enhance the luminance. The reflector 5 is manufactured by injection molding of synthetic resin or the like.

The condenser lens 6 disposed at the exit side of the reflector 5 condenses light incident from the light source 4 side into substantially parallel light. For example, a linear Fresnel lens having uneven grooves extending in the longitudinal direction (X-axis direction) is provided at the exit surface, for example. The linear Fresnel lens may be provided at the incident surface of the condenser lens 6. The linear Fresnel lens has uneven grooves, corresponding to the inclined portion of the curved surface of a convex lens (cylindrical lens) and arranged in the short side direction (Y-axis direction). The linear Fresnel lens includes periodical portions in a number equal to the number of light sources 4 (arranged in the short side direction).

The light distribution and field-of-view adjustment lens 7 arranged at the exit side of the condenser lens 6, changes the optical axis of the light emitted from each part of the exit surface in the Y-Z plane (optical axis tilt, peak shift), and adjusts the diffusion in the Y-axis direction at each part. The light distribution and field-of-view adjustment lens 7 includes a plurality of (many) minute prisms having uneven grooves extending in the X-axis direction, for example, at either the incident surface or the exit surface, and a plurality of (many) minute lenticular lenses having uneven grooves extending in the same direction. These prisms and lenticular lenses may be integrated as compound lenses. When the compound lenses are provided at one surface, a plurality of (many) minute lenticular lenses having uneven grooves extending in the orthogonal Y-axis direction and adjusting the diffusion and luminance uniformity in the X-axis direction may be provided at the other surface.

The optical sheet 8 disposed at the exit side of the light distribution and field-of-view adjustment lens 7 is a diffusion sheet or a polarization reflective sheet, but is not limited to this, and may be, for example, a prism sheet or a louver sheet. The diffusion sheet diffuses passing light. The polarization reflective sheet passes polarized light in a predetermined direction and reflects polarized light in a direction orthogonal to that predetermined direction.

The top frame 9 is disposed at the exit surface side of the optical sheet 8, and the top frame 9 is fixed to the bottom frame 2. The top frame 9 is formed of resin, sheet metal, or the like.

Although the planar illumination device 1 is illustrated as a planar shape, the planar illumination device 1 may be curved.

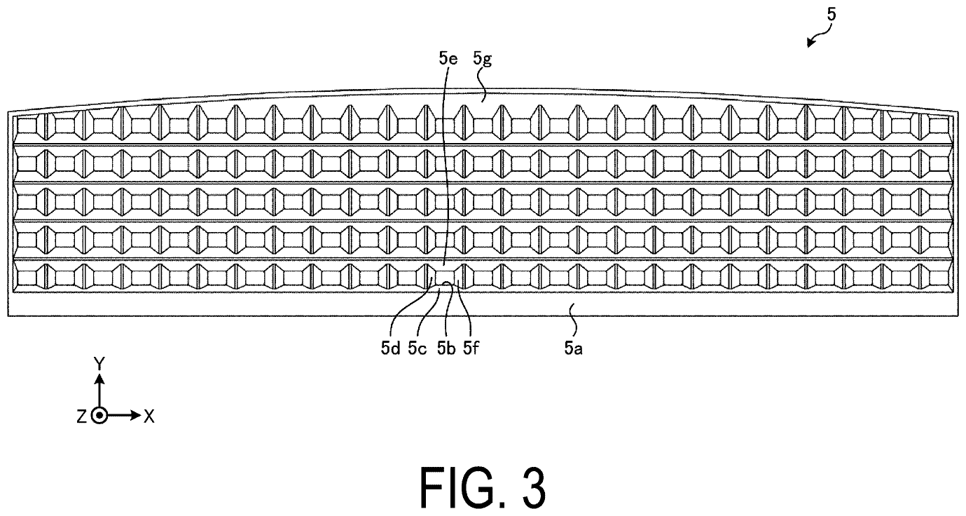

FIG. 3 is a plan view of the reflector 5. In FIG. 3, the outside of the reflector 5 is surrounded by a sidewall 5a, and the inside of the reflector 5 is composed of respective segments for the corresponding light sources 4. Each segment has a substantially rectangular opening 5b, the light source 4 being exposed and arranged in the opening 5b, and a plurality of inclined reflective surfaces 5c, 5d, 5e, and 5f surrounding the opening 5b and opening toward the exit surface side. In addition, the reflector 5 has an irregular shape convex outward from a center part over substantially the entire length of the upper side. The reflective surface of the irregular shape area with the planar shape at the upper side being non-rectangular, is extended to the outer edge side as an extension section 5g. In the present embodiment, the extension section 5g is provided by tilting the reflective surfaces after making the opening of the irregular shape area the same shape as the opening 5b other than the irregular shape area. That is, the plurality of openings 5b exposing the light sources 4 of the reflector 5, are arranged in the same shapes and in a grid pattern, including the irregular shape area, and the reflective surface at the outer edge side of the irregular shape area is adjusted corresponding to the shape of the outer edge of the irregular shape area. In other words, in FIG. 3, the ridge lines formed by the reflective surfaces 5d and 5f extend linearly in one direction (Y direction), the ridge lines formed by the reflective surfaces 5c and 5e extend linearly in a direction orthogonal to the one direction (X direction), and only the ridge lines of the extension section 5g extend non-linearly (the valley line at the root is linear). With such a configuration, molding of the reflector 5 (manufacturing of a mold for molding the reflector 5) is facilitated. In addition, since the reflective surface can be made as close as possible to the light source 4 even at the irregular shape area, a decrease in luminance can be reduced. The extension section 5g may include two or more surfaces, and may include, for example, an inclined surface and a surface extending substantially parallel to the Z-axis. By including a surface extending substantially parallel to the Z-axis along the shape of the outer edge (e.g., at the opening 9a side of the inclined surface) in at least a part of the irregular shape area, the inclination angle of the reflective surface at the extension section 5g can be made constant over the entire length, and molding of the reflector 5 (manufacturing of a mold for molding the reflector 5) is further facilitated. This is also applicable to a case including, for example, an arc portion at a part of one side, or at a plurality of sides, of the outer edge of the rectangular opening, or a case including a straight line part not parallel to the grid, in addition to the opening 9a (exit surface la, light emitting area) shape of the present embodiment. The irregular shape area is not limited to a shape convex outward, but may also be concave inward. Further, instead of making the opening at the irregular shape area the same shape as the opening 5b at other than the irregular shape area, for example, the extension section 5g may be provided with a larger opening at the irregular shape area.

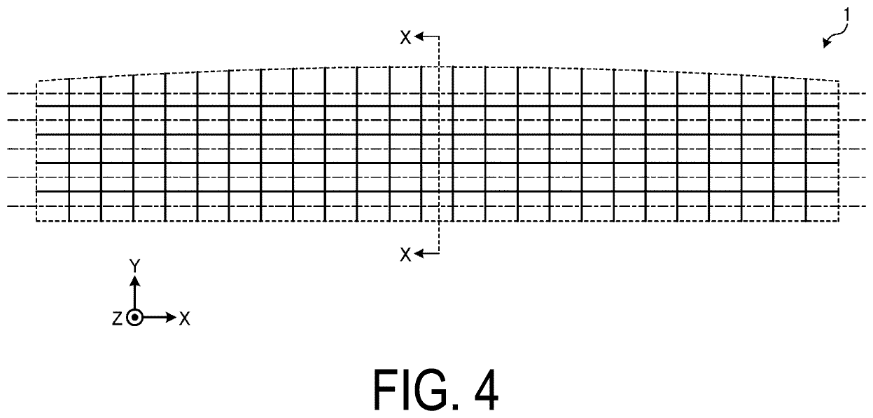

FIG. 4 is a diagram simply illustrating the light emitting area of the planar illumination device 1 and the light condensing position with the light source arranged. In FIG. 4, the outline indicated by a broken line indicates the light emitting area. Here, a center part of the upper side is irregular convex outward. Further, a plurality of dashed lines extending in the horizontal direction (X-axis direction) of the drawing are the light condensing position (focal position) of a linear Fresnel lens 6a, and the light sources 4 are arranged at this light condensing position. In addition to the case with the light condensing position (focal position) of the linear Fresnel lens 6a and the positions of the linearly arranged light sources 4 coinciding with each other, the light condensing position and the positions of the light sources 4 may be parallel to each other with some distance apart. For example, by relatively shifting the central axis of the linear Fresnel lens 6a (the light condensing position, of the linear Fresnel lens 6a, extending linearly) with respect to the optical axis of the light sources 4 in the direction of arrangement of the prisms of the linear Fresnel lens 6a in a plane perpendicular to the optical axis, the light exiting from the linear Fresnel lens 6a can be inclined in the direction of arrangement of the prisms of the linear Fresnel lens 6a with respect to the optical axis of the light sources 4.

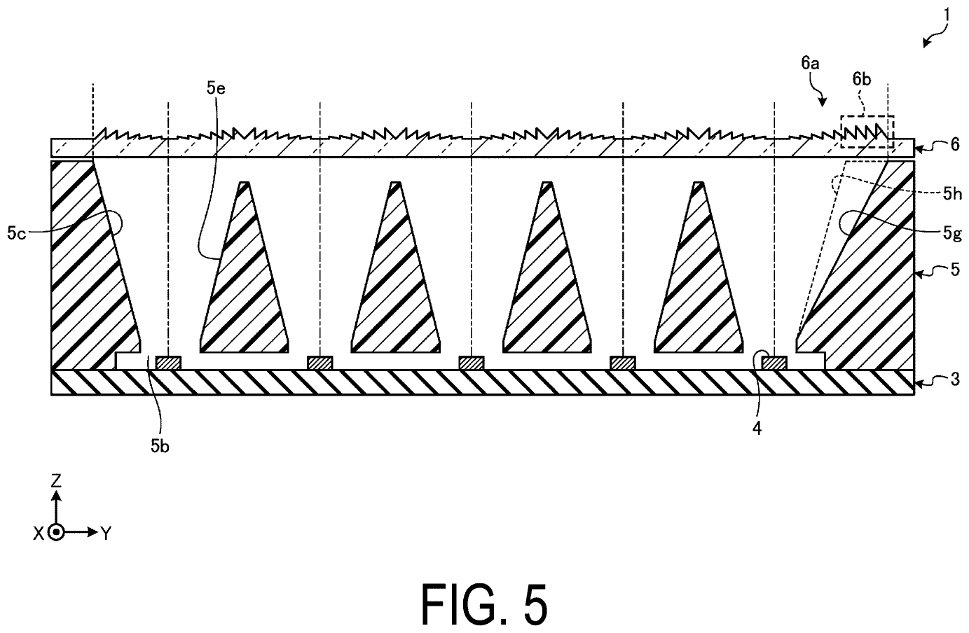

FIG. 5 is a cross-sectional view of the planar illumination device 1 corresponding to the X-X section of FIG. 4, and the bottom frame 2, the light distribution and field-of-view adjustment lens 7, the optical sheet 8, and the top frame 9 are not illustrated. In FIG. 5, except for the irregular shape area at the right side, the positions of the reflective surfaces 5c and 5e of the reflector 5 with respect to each light source 4 are almost the same in each segment, but in the irregular shape area at the right side, a removed section 5h is removed from the outer reflective surface to become the extension section 5g. This eliminates the removed section 5h having obstructed the light from the light source 4 adjacent to the irregular shape area, and allows the light to reach the end part of the light emitting area, thereby preventing the generation of a dark area in the irregular shape area and improving the luminance uniformity.

Additionally, the linear Fresnel lens 6a of the condenser lens 6 located at the exit surface side of the extension section 5g is an extension section 6b with the prism extending outward and continuing, unlike other areas. Thus, the condensing function is maintained even at the end part of the light emitting area, and luminance uniformity is further improved.

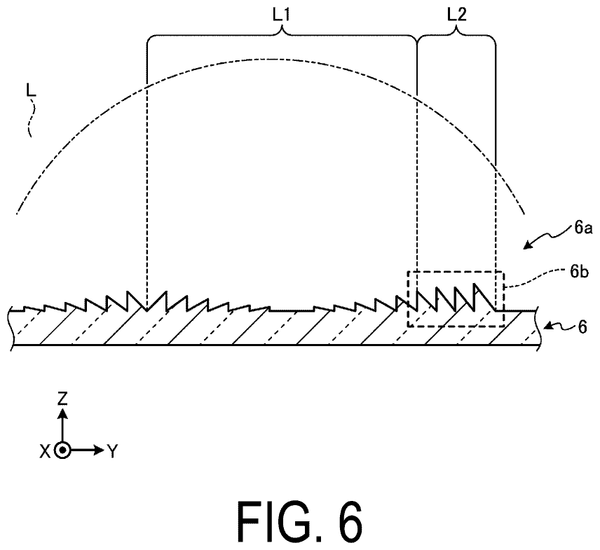

FIG. 6 is an enlarged view of the extension section 6b of the condenser lens 6, and the extension section 6b of the prism is extended corresponding to a convex lens curved surface L of the cylindrical lens corresponding to the linear Fresnel lens 6a. That is, the other area in the segment corresponds to a partial curved surface L1 of the convex lens curved surface L, while the extension section 6b corresponds to a partial curved surface L2 continuing to the partial curved surface L1. Thus, the condensing by the linear Fresnel lens 6a is continuous even at the irregular shape area, and the occurrence of unevenness is prevented, and luminance uniformity is further improved.

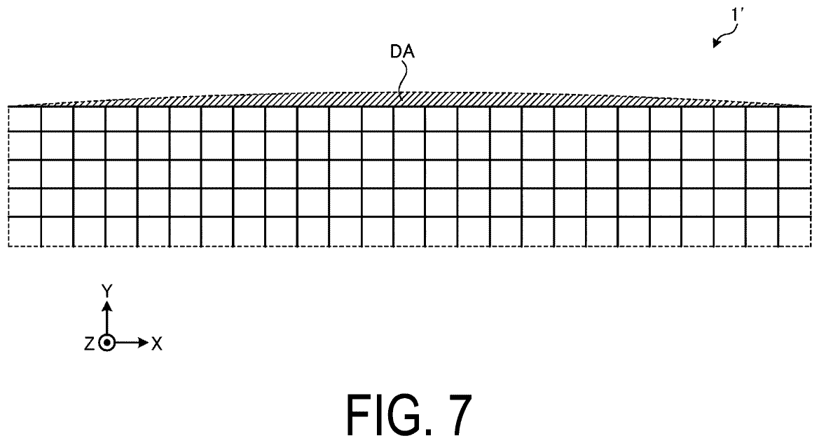

FIG. 7 is a diagram illustrating an example with a dark area DA occurring in a planar illumination device 1′ of a comparative example due to the planar shape irregular and non-rectangular. In FIG. 7, the region surrounded by a broken line is a light emitting area of the planar illumination device 1′, and the upper portion in the diagram has a planar shape irregular and non-rectangular. Each of the small squares indicates a segment, and in FIG. 7, an area occurs projecting due to an irregular shape from the upper side of the segments arranged laterally at the upper side. In the area projecting due to the irregular shape, the light sources are difficult to arrange linearly along the light condensing position of the linear Fresnel lens due to the structural restriction of the frame edge part (even when a linear Fresnel lens can be provided). In addition, since each segment is surrounded by the reflective surfaces on four sides, light is not supplied to the upper irregular shape area and the dark area DA occurs, thereby lowering the luminance uniformity.

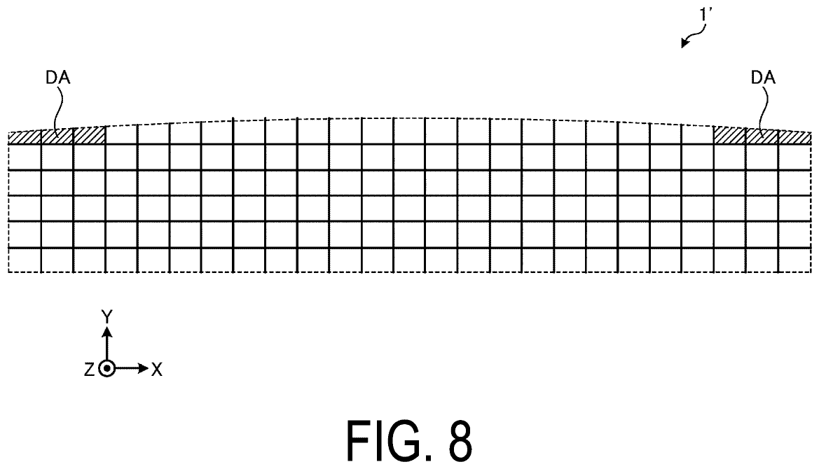

FIG. 8 is a diagram illustrating another example with the dark area DA occurring in the planar illumination device 1′ of a comparative example due to the planar shape irregular and non-rectangular. In FIG. 8, the irregular shape area is included in the sequence of segments. In this case, at several segments of both ends (three segments each in the illustrated example), the light sources are difficult to arrange along the light condensing position of the linear Fresnel lens due to the structural restriction of the frame edge part, so that the dark area DA occurs.

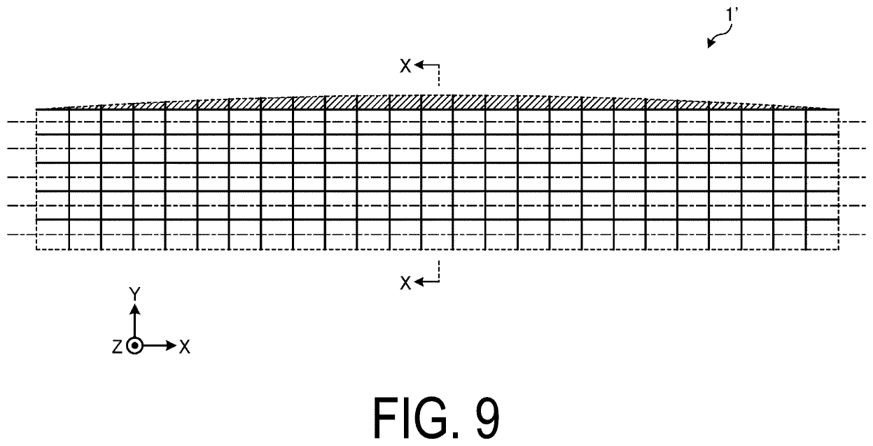

FIG. 9 is a diagram illustrating an example of the light condensing position with the light emitting area and the light sources arranged in the planar illumination device 1′of the comparative example, and corresponds to the arrangement of the light emitting area and the segments in FIG. 7. In FIG. 9, a plurality of dashed lines extending in the horizontal direction (X-axis direction) are the light condensing position (focal position) of linear Fresnel lens 6a′, and light sources 4′are arranged at the light condensing position.

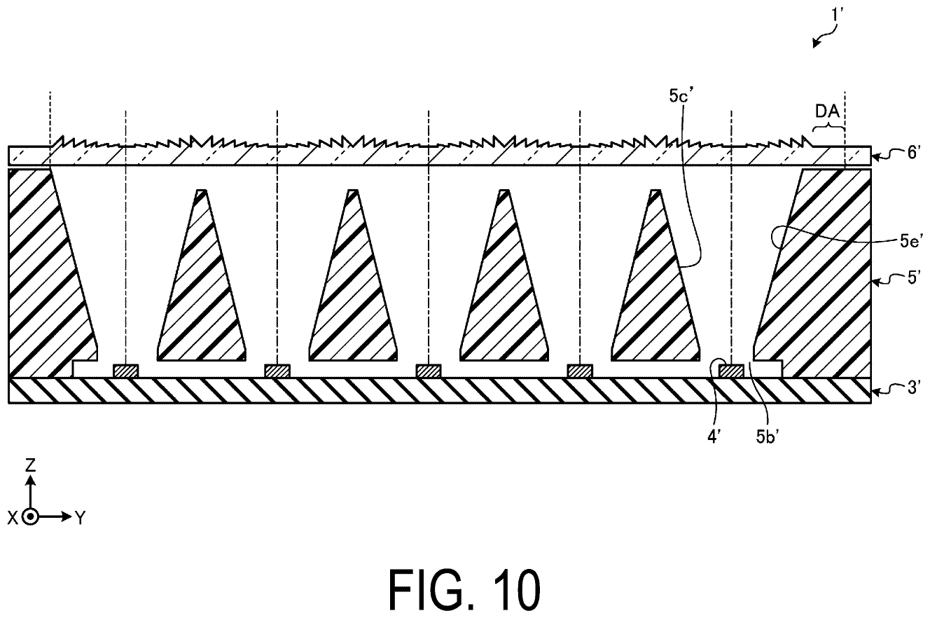

FIG. 10 is a cross-sectional view of the planar illumination device 1′corresponding to the X-X section of FIG. 9, and the bottom frame, the light distribution and field-of-view adjustment lens, the optical sheet, and the top frame are not illustrated. In FIG. 10, a plurality of light sources 4′are arranged on a substrate 3′, and a reflector 5′is arranged at the exit side of the light sources. Each light source 4′is exposed from the opening 5b′, and reflective surfaces 5c′ and 5e′ are arranged at both sides of the opening 5b′.

In FIG. 10, since the positions of the reflective surfaces 5c′ and 5e′ of the reflector 5′ with respect to each light source 4′are the same at each segment, the light does not reach the end part of the light emitting area due to the reflective surface 5e′ and the frame continuing from the reflective surface 5e′ at the irregular shape area at the right side, generating the dark area DA.

In this regard, in the planar illumination device 1 of the embodiment illustrated in FIG. 5, the removed section 5h is removed from the outer reflective surface in the irregular shape area at the right side, generating the extension section 5g. That is, at an area not enabling arrangement of (due to a lack of space or a small space) the light sources 4 at the light condensing position (of a virtually provided linear Fresnel lens) due to a planar shape of the light emitting area being irregular and non-rectangular in the planar illumination device 1, the segment of the reflector 5 adjacent to the area is extended toward the outer edge side of the planar illumination device 1. Thus, the light from the light source 4 reaches the end part of the light emitting area, so that the generation of a dark area at the irregular shape area is prevented and luminance uniformity is improved.

Further, in the planar illumination device 1 of the embodiment illustrated in FIG. 5, since the extension section 6b of the prism is provided at the linear Fresnel lens 6a corresponding to the portion of the extension section 5g extended by the removed section 5h of the reflector 5, the light-condensing function is also maintained, and the luminance uniformity of the portion supposed to be the dark area, is further improved. Furthermore, since the extension section 6b of the prism is continuously provided in accordance with the curved surface of the cylindrical lens corresponding to the linear Fresnel lens 6a, the occurrence of unevenness is prevented, and the luminance uniformity is further improved.

Further, in the planar illumination device 1 of the embodiment illustrated in FIG. 5, the extending of the segment toward the outer edge side and the extending of the prism of the linear Fresnel lens 6a, are performed in a direction orthogonal to the direction of extension of the uneven grooves of the linear Fresnel lens 6a. This enables simultaneous realization of the effect of extending the segment and the effect of extending the prism of the linear Fresnel lens 6a.

Further, other linear Fresnel lens may be provided having uneven grooves extending in a direction orthogonal to the direction of the uneven grooves of the linear Fresnel lens 6a extending. This allows for a variety of light distributions.

Further, the other linear Fresnel lens is formed at a surface of the linear Fresnel lens, the surface being at an opposite side of the linear Fresnel lens 6a, or is formed separately from the linear Fresnel lens 6a. This increases the degree of freedom in the configuration of both linear Fresnel lenses.

Although the embodiments of the disclosure have been described above, the disclosure is not limited to the above embodiments, and various modifications can be made without departing from the spirit of the disclosure.

As described above, the planar illumination device according to the embodiment is a direct-type planar illumination device having a linear Fresnel lens, and includes:
a plurality of light sources linearly arranged on a substrate along a light condensing position of the linear Fresnel lens; and
a reflector having a plurality of reflective surfaces forming respective segments, each segment surrounding a corresponding one of the plurality of light sources.

At an area not enabling arrangement of the light sources along the light condensing position because the planar shape of the light emitting area of the planar illumination device is irregular and non-rectangular, the segment of the reflector adjacent to the area is extended toward the outer edge side of the planar illumination device. This prevents generation of a dark area in the irregular shape area and improves luminance uniformity.

Further, at an area not enabling arrangement of the light sources along the light condensing position because the planar shape of the light emitting area of the planar illumination device is irregular and non-rectangular, a prism of the linear Fresnel lens is extended. This maintains the light-condensing function of the linear Fresnel lens, and further improves the luminance uniformity of the area having been supposed to become the dark area.

Further, the prism of the linear Fresnel lens is extended corresponding to a curved surface of a cylindrical lens corresponding to the linear Fresnel lens. This causes the condensing by the linear Fresnel lens to be continuous even at the irregular shape area, prevents the occurrence of unevenness, and further improves the luminance uniformity.

Further, the extending of the segment toward the outer edge side and the extending of the prism of the linear Fresnel lens, are performed in a direction orthogonal to the direction of extension of the uneven grooves of the linear Fresnel lens extending. This enables to achieve simultaneously the effect of extending the segment and the effect of extending the prism of the linear Fresnel lens.

Further, other linear Fresnel lens is provided having uneven grooves extending in a direction orthogonal to the direction of the uneven grooves of the linear Fresnel lens extending. This allows for a variety of light distributions.

Further, the other linear Fresnel lens is formed at a surface of the linear Fresnel lens, the surface being at an opposite side of the linear Fresnel lens, or is formed separately from the linear Fresnel lens. This increases the degree of freedom in the configuration of both linear Fresnel lenses.

Further, the reflector has a plurality of openings exposing the light sources, the plurality of openings are arranged in the same shape and in a grid pattern, at the area including the irregular shape area, and the reflective surface at the outer edge side of the irregular shape area is adjusted corresponding to the shape of the outer edge of the irregular shape area. This facilitates manufacturing of mold for the reflector (mold for molding the reflector).

Further, a direct-type planar illumination device having a linear Fresnel lens, includes:
a plurality of light sources linearly arranged on a substrate along a light condensing position of the linear Fresnel lens; and
a reflector having a plurality of reflective surfaces forming a plurality of segments, each segment surrounding a corresponding one of the plurality of light sources.

At an area not enabling arrangement of the light sources along the light condensing position because the planar shape of the light emitting area of the planar illumination device is irregular and non-rectangular, a prism of the linear Fresnel lens is extended. This prevents generation of a dark area in the irregular shape area and improves luminance uniformity.

The disclosure is not limited by the above embodiments. The disclosure also includes configurations combining the above-described components appropriately. Further effects and modifications can be easily derived by those skilled in the art. Thus, a broader aspect of the disclosure is not limited to the above-described embodiments, and various modifications can be made.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A direct-type planar illumination device comprising:
a plurality of light sources; and
a reflector having a plurality of reflective surfaces forming respective segments, each segment surrounding a corresponding one of the plurality of light sources,
wherein
at an area not enabling arrangement of the light sources because a planar shape of a light emitting area of the planar illumination device is irregular and non-rectangular, a segment of the reflector adjacent to the area is extended toward an outer edge side of the planar illumination device.

2.-8. (canceled)

9. The planar illumination device according to claim 1, wherein the reflective surface at the outer edge side of the irregular shape area has an inclination angle different from an inclination angle of the reflective surface at an area other than the irregular shape area in a sectional view parallel to an optical axis.

10. The planar illumination device according to claim 9, wherein the reflective surface at the outer edge side of the irregular shape area forms a non-linear ridge line and a linear valley line at a root, a plurality of the valley lines at the root all extending linearly in a same direction across a plurality of the segments aligned in one direction.

11. The planar illumination device according to claim 10, wherein the valley lines in the plurality of segments arranged at the outer edge side of the irregular shape area are formed on a common straight line along an entire length of the irregular shape area.

12. The planar illumination device according to claim 1, wherein
the reflector has a plurality of openings exposing the light sources, the plurality of openings are arranged, including the irregular shape area, in the same shape as each other and in a grid pattern, and the reflective surface at an outer edge side of the irregular shape area is adjusted corresponding to the shape of the outer edge of the irregular shape area.

13. The planar illumination device according to claim 1, wherein the reflective surface at the outer edge side of the irregular shape area includes an inclined surface, and a surface extending substantially parallel to a thickness direction along the shape of the outer edge of the irregular shape area at an exit surface side of the inclined surface.

14. The planar illumination device according to claim 1, comprising the condenser lens arranged for the plurality of light sources, wherein
at the area not enabling arrangement of the light sources because the planar shape of the light emitting area of the planar illumination device is irregular and non-rectangular, the condenser lens is extended.

15. The planar illumination device according to claim 1, wherein the plurality of light sources can be driven by local dimming.

16. A direct-type planar illumination device comprising:
a plurality of light sources; and
a condenser lens arranged for the plurality of light sources,
wherein
at an area not enabling arrangement of the light sources because a planar shape of a light emitting area of the planar illumination device is irregular and non-rectangular, the condenser lens is extended.

17. The planar illumination device according to claim 16, wherein the condenser lens is a linear Fresnel lens.

18. The planar illumination device according to claim 17, wherein
the extending of the linear Fresnel lens is performed corresponding to a curved surface of a cylindrical lens corresponding to the linear Fresnel lens.

19. The planar illumination device according to claim 17, wherein
the extending of the linear Fresnel lens is performed in a direction orthogonal to a direction of extension of the uneven grooves of the linear Fresnel lens.

20. The planar illumination device according to claim 17, comprising:
another linear Fresnel lens having uneven grooves extending in a direction orthogonal to a direction of extension of the uneven grooves of the linear Fresnel lens.

21. The planar illumination device according to claim 20, wherein the other linear Fresnel lens is formed at a surface of the linear Fresnel lens, the surface being at an opposite side of the linear Fresnel lens, or is formed separately from the linear Fresnel lens.

22. The planar illumination device according to claim 16, further comprising a reflector having a plurality of reflective surfaces forming a plurality of segments, each segment surrounding a corresponding one of the plurality of light sources.

23. The planar illumination device according to claim 16, wherein the plurality of light sources are linearly arranged along a light condensing position of the condenser lens.

24. The planar illumination device according to claim 16, wherein the plurality of light sources can be driven by local dimming.

25. A direct-type planar illumination device comprising:
a plurality of light sources; and
a reflector having a plurality of reflective surfaces forming respective segments, each segment surrounding a corresponding one of the plurality of light sources,
wherein
a shape of the reflective surfaces of an area where the planar shape of a light emitting area of the planar illumination device is irregular and non-rectangular is adjusted according to a position of the end part of the light emitting area.
